(19) United States
(12) Patent Application Publication
(10) Pub. No.: US 2003/0053573 A1
(43) Pub. Date: Mar. 20, 2003

(54) Microcontroller having a transmission-bus-interface

(76) Inventors: John Bree, Gilbert, AZ (US); Joseph W. Triece, Phoenix, AZ (US)

Correspondence Address: BAKER BOTTS, LLP, 910 LOUISIANA, HOUSTON, TX, 77002-4995, US

(21) Appl. No.: 09/957,281

(22) Filed: Sep. 20, 2001

(51) Int. Cl. H04L 7/00

(52) U.S. Cl. 375/355

(57) ABSTRACT

A microcontroller has a central processing unit coupled with a control unit for controlling a transmission bus. The transmission bus has at least one data and one clock signal with recessive and dominant states. The system comprises a bus controller for controlling a data and a clock line, a stretch control unit coupled with the clock line of the bus receiving a stretch activation signal, and a delay unit for delaying the stretch activation signal until a transition from a recessive to a dominant state on the clock line takes place. The bus can be an I²C-bus.

### FIELD OF THE INVENTION

The present invention concerns a microcontroller having a transmission bus having at least one data and one clock signal with recessive and dominant states. In particular the present invention is useful for an I²C-bus. Furthermore, the present invention concerns a method of controlling a transmission bus having at least one data and one clock signal with recessive and dominant states, such as an I²C-bus within an I²C-bus network.

### BACKGROUND OF THE INVENTION

The I²C-bus configuration is a bus system for relatively low speed communication of microcontrollers and peripheral controllers using two signal lines. One signal line carries a clock signal and the other carries serial data signals synchronized with the clock signal. A device that transmits signals onto the I²C-bus is called the transmitter and a device that receives signals is the receiver. Furthermore, a device that controls signal transfers on the line in addition to controlling the clock frequency is the master and a device that is controlled by the master is the slave. The master can transmit or receive signals to or from a slave, respectively, or control signal transfers between two slaves, where one is the transmitter and the other is the receiver. It is possible to combine several masters, in addition to several slaves, onto an I²C-bus to form a multi-master system. If more than one master simultaneously tries to control the line, an arbitration procedure decides which master gets priority.

The maximum number of devices connected to the bus is dictated by the maximum allowable capacitance on the lines, and the protocol's addressing limit which can be, for example, 16 k or less depending on how many address bits are used. Often, a high speed microcontroller or microprocessor is a master devices on a I²C-bus coupled with a plurality of peripherals and other lower speed microcontrollers as slave devices for executing peripheral and/or supporting tasks.

Simplicity of the I²C system is primarily due to the bidirectional 2-wire design, a serial data line (SDA) and serial clock line (SCL), and to the protocol format. Because of the efficient 2-wire configuration used by the I²C interface compared to that of other serial interfaces, reduced board space and pin count allows the designer to have more creative flexibility while reducing interconnecting cost.

For operating a slave over the I²C-bus only six simple operating codes are required for transmitting or receiving bits of information. These operating codes are: A start bit; A slave address; A read/write bit which defines whether the slave is a transmitter or receiver; An acknowledge bit; Message bits divided into 8-bit segments; And a stop bit.

If both the data and clock lines are HIGH, the bus is not busy. To attain control of the bus, a start condition is needed from a master; and to release the lines, a stop condition is required. The start condition is defined as a HIGH-to-LOW transition of the data line while the clock line is in a HIGH state. The stop condition is defined as a LOW-to-HIGH transition of the data line while the clock line is in a HIGH state.

The master always generates the start and stop conditions. After the start condition, the bus is in the busy state. The bus becomes free after the stop condition. After a start condition one data bit is transferred during each clock pulse. The data must be stable during the HIGH-period of the clock. The data line can only change when the clock line is at a LOW level. Normally each data transfer is done with 8 data bits and 1 acknowledge bit (byte format with acknowledge). Each data transfer needs to be acknowledged. The master generates the acknowledge clock pulse. The transmitter releases the data line (SDA-HIGH) during the acknowledge clock pulse. If there was no error detected, the receiver will pull down the SDA-line during the HIGH period of the acknowledge clock pulse.

If a slave receiver is not able to acknowledge, the slave will keep the SDA line HIGH and the master can then generate a STOP condition to abort the transfer. If a master receiver keeps the SDA line HIGH, during the acknowledge clock pulse the master signals the end of data transmission and the slave transmitter releases the data line to allow the master to generate a STOP-condition.

If more than one device are potential masters and more than one desires access to the bus, an arbitration procedure takes place: if a master transmits a HIGH level and another master transmits a LOW level, the master with the LOW level will get the bus and the other master will release the bus; and the clock line switches immediately to the slave receiver mode. This arbitration could carry on through many bits (address bits and data bits are used for arbitration).

Slow peripherals and slow microcontrollers might not be able to keep up with the normal clock speed of an I²C-bus. Therefore, the I²C-bus protocol allows slower devices to stretch the clock until they finished their transaction. Therefore, the slower device screens the clock signal SCL and if this signal is low it pulls down the clock signal SCL to stretch the clock pulse until the data are stable on the data lines. Some microcontrollers which are set as slaves might have to operate even slower peripheral devices such as serial data interfaces, wireless data interfaces, infrared data interfaces, etc. Those peripherals might need a significant clock stretch for any type of data transfer as described above. To initiate a clock stretch, the microcontroller screens the clock signal until it is in a low state and then asserts the clock stretch procedure. However, in some circumstances the low phase might already be low and the time for the next transition to a high phase too short. Thus, the clock signal will transit between the screening and the clock stretch procedure resulting in a violation of the I²C-bus protocol as the high time will be too short. Thus an error will occur and the transmission will have to be repeated.

### SUMMARY OF THE INVENTION

The present application overcomes these problems by a method of operating a data transmission on a transmission bus having at least one data and one clock signal with recessive and dominant states during which the clock signal can be stretched the method comprises the steps of:

activating a data transfer asynchronously to the clock signal;

screening the clock signal;

waiting for a transition from a recessive to a dominant state;

stretching the dominant state until the data transmission is completed.

Another embodiment comprises a control unit for controlling a transmission bus having at least one data and one clock signal with recessive and dominant states comprising a bus controller for controlling a data and a clock line. A stretch control unit is provided which is coupled with the clock line of the bus receiving a stretch activation signal. A delay unit for delaying the stretch activation signal until a transition from a recessive to a dominant state on said clock line takes place ensures no violation of a respective bus protocol.

Other technical advantages of the present disclosure will be readily apparent to one skilled in the art from the following figures, descriptions, and claims. Various embodiments of the present application obtain only a subset of the advantages set forth. No one advantage is critical to the embodiments.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram a microcontroller having an I²C-bus according to the prior art;

FIG. 2 is a block diagram of an I²C-bus network according to the prior art;

FIG. 3 is a block diagram of a microprocessor core coupled with an I²C-unit in accordance with another embodiment of the present application;

FIG. 4 is timing diagram showing a worst case according to the prior art;

FIG. 5 is an exemplary embodiment of a synchronization control circuit according to FIG. 3;

FIG. 6 is a timing diagram of internal and I²C-bus signals according to an embodiment of the present application; and

FIG. 7 is a flow chart showing an exemplary software embodiment according to the present invention.

### DETAILED DESCRIPTION OF THE PREFERRED EMBODIMENTS

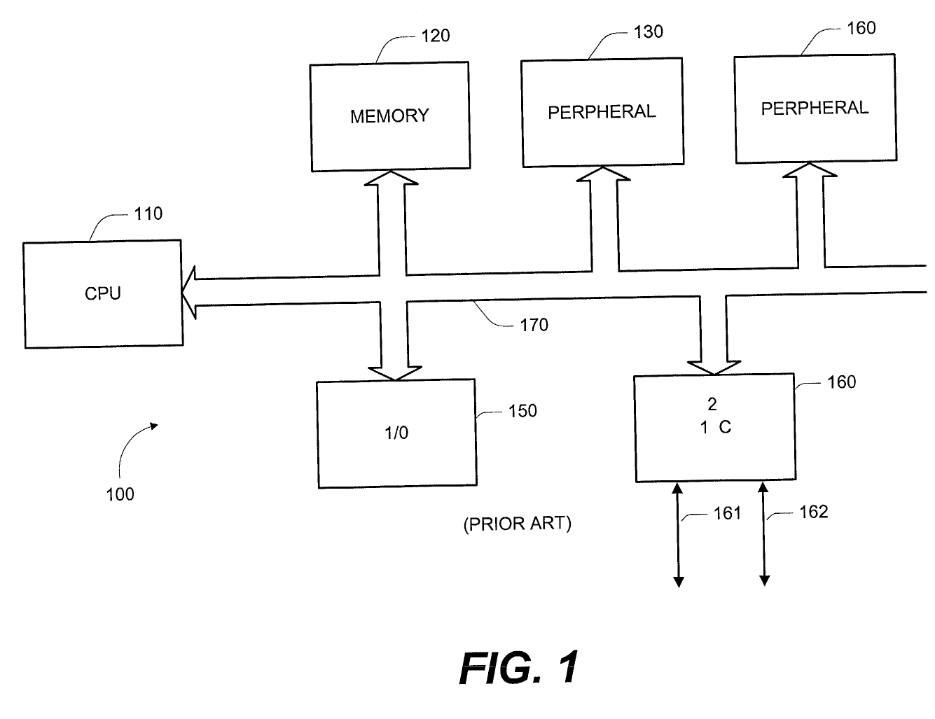

The present invention will be described with embodiments using an I²C-bus protocol. However, the present invention is not limited to an I²C-bus. Any bus-system using separate data and clock lines with recessive and dominant states can be improved by the present invention. Before explaining exemplary embodiments of the present invention a typical transmission network using separate data and clock signals with recessive and dominant states according to the prior art will now be described with respect to an I²C-network. FIG. 1 depicts a microcontroller 100 arrangement. Usually, a microcontroller comprises a central processing unit 110 which is coupled with one or more bus systems. In the exemplary embodiment of FIG. 1 only one bus 170 is shown. This bus 170 couples central processing unit 110, for example, with a memory unit 120 for storing program and data information, a plurality of peripheral units 130..140, such as analog-to-digital-converters, watchdog timers, timer units, etc. Another peripheral unit is shown with numeral 150 as an I/O unit 150 coupled through bus 170 with the central processing unit 110. Furthermore an I²C controller unit 160 is provided which is connected to internal bus 170 and can be coupled to an I²C-bus consisting of data line 161 and clock line 162.

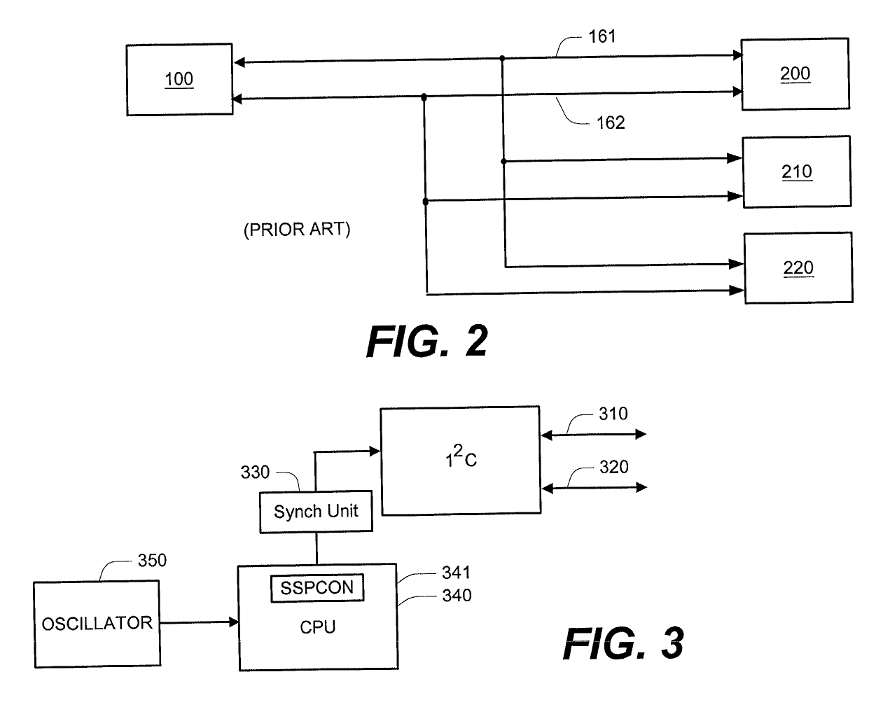

An I²C-network with multiple controllers, peripheral units is depicted in FIG. 2. In FIG. 2, same numerals show similar elements. A master device is shown as the controller 100 depicted in FIG. 1. In addition, a plurality of other devices 200, 210, and 220 are coupled to the I²C-bus 161, 162.

The system according to FIGS. 1 and 2 uses the synchronous serial protocol of an I²C-bus with a dominant and a recessive bit scheme as described above. The I²C-bus allows multiple devices 100, 200, 210, 220 to communicate on a common serial bus 161, so that all users can assert the bus at the same time. Each device 100, 200, 210, and 220 must arbitrate the bus to determine which device 100, 200, 210, 220 will be given control of the bus at any given time. A dominant bit is assigned to one logic state and the recessive bit is assigned to the opposite state. A dominant bit is the logic state when a device is asserting the state, while a recessive bit is the state of the bus when no devices are asserting the bus. Therefore, a recessive bit is the state of the bus when the bus is left floating. In this type of implementation, an external pull-up or pull-down device is typically required depending upon the logic state of the recessive bit.

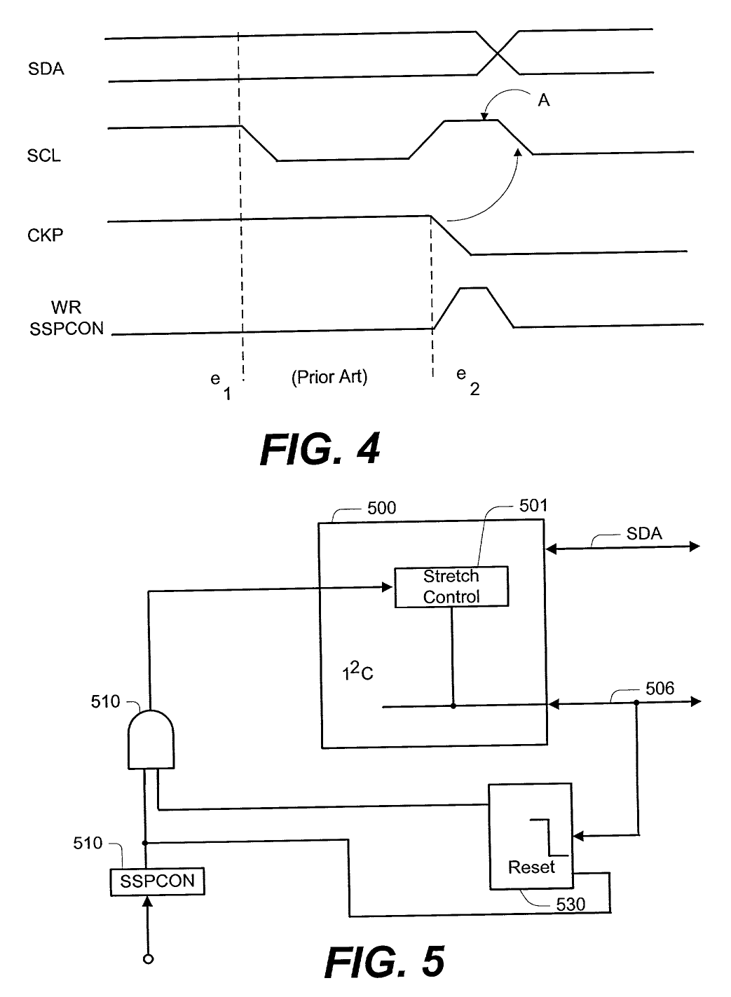

According to the prior art, each device controlling the bus must maintain the timing characteristics of the I²C-specification. As described above, this is not always the case in particular when slow systems are connected with the I²C-bus. FIG. 4 depicts such a bus timing violation which can take place with an arrangement according to FIGS. 1 and 2. FIG. 4 shows the two I²C-bus signals 161 and 162 as the data signal SDA and the clock signal SCL. Two typical internal signals CKP and WRSSPCON are also shown. CKP is an internal clock assert signal which determines whenever and for how long the SCP clock signal of the I²C-bus has to be stretched to accommodate the internal processes of a slower device as needed. For example, the slower device can comprise an slow non-volatile memory which has to be written according to its timing requirements which may be longer than the dominant cycle time. Furthermore, the asynchronous timing within the central processing unit with respect to the I²C-bus timing can shorten the dominant cycle significantly and violate the timing as will be explained now.

For example, a write to a register which initiates a data transfer on the I²C-bus may start at a time t₂. At this time the dominant cycle of the I²C-clock cycle may be already advanced as it started its dominant cycle at time t₁. Therefore, at this time the clock signal SCL is in the dominant state. However, there exists a scenario when the user attempts to “stretch” the dominant state at the same time the clock signal SCL transitions to the recessive state. The clock assert signal pulls the clock signal SCL back into the dominant state. This is shown by numeral A in FIG. 4. The resulting very short recessive cycle time at time A for signal SCL violates the I²C-specification and results into an erroneous transmission.

FIG. 3 shows an exemplary embodiment of a synchronization unit in combination with a microcontroller as shown in FIGS. 1 and 2. This synchronization unit avoids the above cited problems and therefore significantly improves data transmission on an I²C-bus, in particular if many different devices having varying speed characteristics are connected to an I²C-network. An I²C-interface unit 300 is coupled with I²C-bus lines for data 310 and clock signals 320. a synchronization unit 330 is coupled between a central processing unit 340 and the I²C-interface unit 300. central processing unit 340 may comprise an internal or external register 341 which is coupled with synchronization unit 330. Central processing unit 340 is also coupled with an oscillator unit 350 which supplies central processing unit 340 with a system clock.

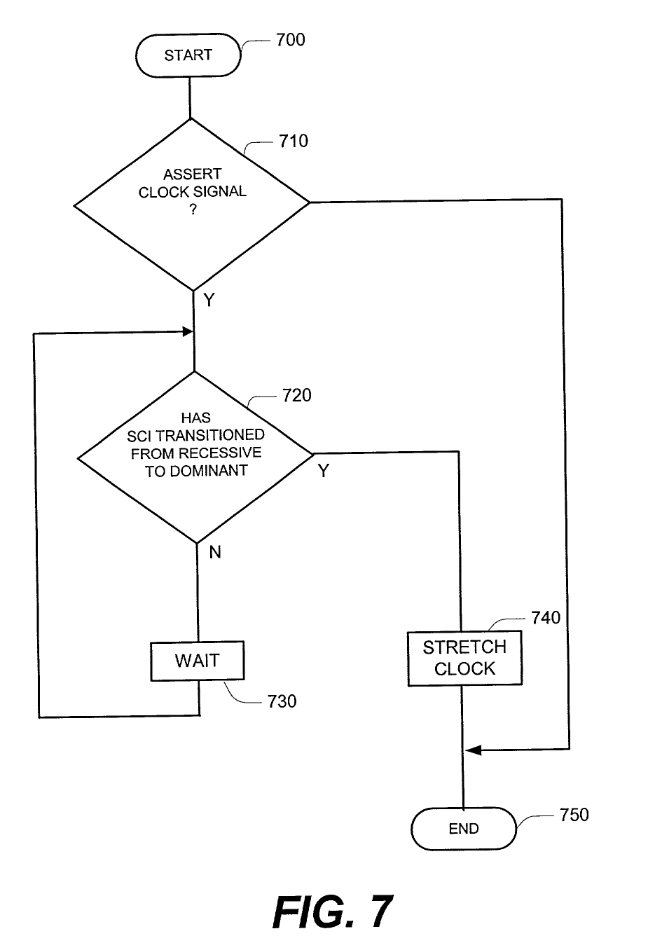

I²C-interface unit 300 has its own timing circuits according to the I²C-specification which runs asynchronously with the system clock provided by oscillator unit 350. Even if the system clock is used by I²C-interface unit 300, usually the system clock has a much higher frequency than the I²C-clock. During execution of a program a transfer of data through the I²C-bus can be initiated. This is done by programming a register, for example register 341 as shown in FIG. 3. Upon setting of the respective bits in this register 341 a transfer of data through I²C-interface unit 300 can be performed. The programming of the register and therefore the transmission start are usually not synchronized with the I²C-clock. If a slow transmission takes place which due to its length requires a clock stretch register 341 will generate a clock stretch signal. This clock stretch signal is then fed to synchronizer unit 330 which delays the respective clock stretch signal until a transition of I²C-clock signal takes place. Furthermore, synchronization unit 330 maintains the minimum required cycle time for the dominant state. In case the microprocessor or device is faster than the I²C-specification synchronization unit 330 lengthens the clock stretch signal appropriately. This synchronization can be performed by a hard-wired synchronization unit as will be shown by an exemplary embodiment in FIG. 5 or by a software solution as will be shown by another exemplary embodiment in FIG. 7. The clock assert signal can be generated by a master or a slave device. In case of a slave device the present invention assures that the clock stretch signal is only asserted once a master device has transferred the I²C-clock signal from a recessive to a dominant state.

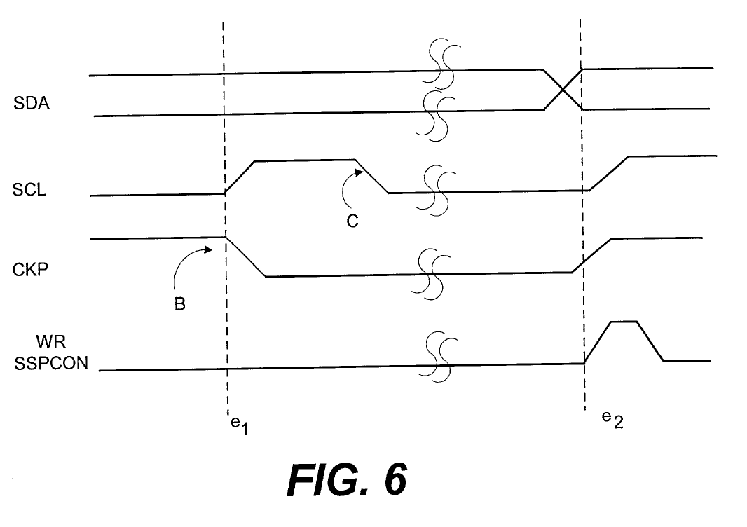

The resulting timing diagram for an exemplary transmission with a clock stretch according to different embodiments of the present invention is shown in FIG. 6. Again, I²C-bus signals SDA and SCL are depicted followed by internal clock assert signal CKP and register write signal WRSSPCON. At a time t₁ central processing unit is assumed to initiate a write signal to register 341 which generates a clock stretch signal CKP as shown by numeral B. However, the clock stretch will not commence until the clock signal SCL transits from a recessive to a dominant state as indicated by numeral C. A second write signal at time t2 terminates the clock stretch. Again, minimum recessive time for the cycle is maintained by the synchronization unit.

FIG. 5 shows a first embodiment of the synchronization unit in combination with an I²C-interface unit. It is assumed that an I²C-interface unit 500 comprises a stretch control unit 501 which generally is the circuitry to assert the clock signal SCL. This unit 501 is coupled with I²C-clock signal SCL. A flip-flop 530 is provided which comprises a set input sensitive to the falling edge of an incoming signal. This input is connected with the I²C-clock signal SCL. The output is coupled with the first input of an AND gate 510 whose output is coupled with stretch control unit 501 of I²C-interface unit 500. A I²C-control register 520 (SSPCON) is provided within a central processing unit of a microcontroller or a controller unit of any I²C-compatible device. This register is coupled with the second input of AND gate 510. Another output of register 520 is coupled with the reset input of flip-flop 530. Register 520 can be written by means of a write signal 540.

This hardware embodiment synchronizes a clock stretch signal generated by register 520. To this end, the I²C-clock signal SCL triggers flip-flop 530. For example, the rising edge of clock stretch signal is fed to the reset input of flip-flop 530 resetting it. Thus, the output of flip-flop 530 stays low until I²C-clock signal SCL transits from its recessive state to a dominant state, in the shown embodiment from a high state to a low state. The circuit design comprises enough signal delay between the output of register 520 which generates the clock stretch signal and the AND gate 510. This results in a logic high signal at the output of AND gate 510 only if the clock signal SCL transitioned from recessive to dominant state. Thus a I²C-clock signal is only stretched starting at the beginning of a dominant clock cycle.

FIG. 7 shows a flow chart according to another exemplary embodiment of the present invention. A faster microcontroller with slow peripherals controlling an I²C-bus whose processing capabilities are not fully needed can use spare processing capacity to secure transmission by means of an I²C-interface using software. The routine can be a sub-routine which is periodically started to secure the I²C-specification. The routine starts at step 700 from where it goes to step 710 in which it is checked whether a clock signal has to be asserted. If not, then the routine ends in step 750. If yes, the routine branches to step 720 where the signal status of I²C-clock signal SCL is checked. If a transition from a recessive to a dominant state took place, the routine branches to step 740. If not, the routine waits in step 730 and continues with step 720. Step 730 can also be omitted and the routine can loop until the transition took place. In step 740 the clock signal will be asserted thus stretching the clock until a respective data transmission has been completed.

As can be readily seen, the present invention is not necessarily limited to an I²C-bus. Any bus system using a recessive and a dominant state similar to an I²C-bus benefits from the present invention. The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. Method of operating a data transmission on a transmission bus having at least one data and one clock signal with recessive and dominant states during which the clock signal can be stretched, comprising the steps of:
activating a data transfer asynchronously to said clock signal;
screening the clock signal;
waiting for a transition from a recessive to a dominant state;
stretching said dominant state until said data transmission is completed.

2. Method according to claim 1, wherein said activation is generated by setting a bit in a control register for said bus.

3. Method according to claim 1, wherein said recessive state is a logic high level and said dominant state is a logic low level.

4. Method according to claim 3, wherein said bus is an I²C-bus.

5. Control unit for controlling a transmission bus having at least one data and one clock signal with recessive and dominant states comprising:
a bus controller for controlling a data and a clock line;
a stretch control unit coupled with said clock line of said bus receiving a stretch activation signal;
a delay unit for delaying said stretch activation signal until a transition from a recessive to a dominant state on said clock line takes place.

6. Control unit according to claim 4 wherein said delay unit comprises flip flop generating an output signal having an input sensitive to a transition from a recessive to a dominant state coupled with said clock line and an AND gate receiving said output signal and said stretch control signal and generating an output signal which is fed to said stretch control unit.

7. Control unit according to claim 4, further comprising a control register, whereby said control register comprises a bit which when set generates said stretch control signal.

8. Control unit according to claim 4, wherein said bus is an I²C-bus.

9. Microcontroller having a central processing unit coupled with a control unit for controlling a transmission bus having at least one data and one clock signal with recessive and dominant states comprising:
a bus controller for controlling a data and a clock line;
a stretch control unit coupled with said clock line of said bus receiving a stretch activation signal;
a delay unit for delaying said stretch activation signal until a transition from a recessive to a dominant state on said clock line takes place.

10. Microcontroller according to claim 8 wherein said delay unit comprises flip flop generating an output signal having an input sensitive to a transition from a recessive to a dominant state coupled with said clock line and an AND gate receiving said output signal and said stretch control signal and generating an output signal which is fed to said stretch control unit.

11. Microcontroller according to claim 8, further comprising a control register, whereby said control register comprises a bit which when set generates said stretch control signal.

12. Microcontroller according to claim 8, wherein said bus is an I²C-bus.
